(19) United States
(12) Patent Application Publication
(10) Pub. No.: US 2008/0181485 A1
(43) Pub. Date: Jul. 31, 2008

(54) SYSTEM AND METHOD OF IDENTIFYING OBJECTS

(76) Inventors: Jeffrey S. Beis, North Vancouver (CA); Babak Habibi, North Vancouver (CA)

Correspondence Address: SEED INTELLECTUAL PROPERTY LAW GROUP PLLC, 701 FIFTH AVE, SUITE 5400, SEATTLE, WA, 98104, US

(21) Appl. No.: 11/957,258

(22) Filed: Dec. 14, 2007

Related U.S. Application Data
(60) Provisional application No. 60/875,073, filed on Dec. 15, 2006.

(51) Int. Cl. G06K 9/00; G06K 9/62

(52) U.S. Cl. 382/153; 382/103; 382/209

(57) ABSTRACT

A system and method for identifying objects using a robotic system are disclosed. Briefly described, one embodiment is a method that captures a first image of at least one object with an image capture device that is moveable with respect to the object, processes the first captured image to determine a first pose of at least one feature the object, determines a first hypothesis that predicts a predicted pose of the identified feature based upon the determined first pose, moves the image capture device, captures a second image of the object, processes the captured second image to identify a second pose of the feature, and compares the second pose of the object with the predicted pose of the object.

### RELATED APPLICATION

This application claims the benefit under 35 U.S.C. § 119(e) of U.S. provisional patent application Ser. No. 60/875,073, filed Dec. 15, 2006, the content of which is incorporated herein by reference in its entirety.

### BACKGROUND OF THE INVENTION

1. Field

This disclosure generally relates to robotic systems, and more particularly to robotic vision systems that detect objects.

2. Description of the Related Art

There are many object recognition methods available for locating complex industrial parts having a large number of detectable features. A complex part with a large number of features provides redundancy, and thus can be reliably recognized even when some fraction of its features are not properly detected.

However, many parts that require a bin picking operation are simple parts which do not have a required level of redundancy in detected features. In addition, the features typically used for recognition, such as edges detected in captured images, are notoriously difficult to extract consistently from image to image when a large number of parts are jumbled together in a bid. The parts therefore cannot be readily located, especially given the potentially harsh nature of the environment, i.e., uncertain lighting conditions, varying amounts of occlusions, etc.

The problem of recognizing a simple part among many parts lying jumbled in a storage bin, such that a robot is able to grasp and manipulate the part in an industrial or other process, is quite different from the problem of recognizing a complex part having many detectable features. Robotic systems recognizing and locating three-dimensional (3D) objects, using either (a) two-dimensional (2D) data from a single image or (b) 3D data from stereo images or range scanners, are known. Single image methods can be subdivided into model-based and appearance-based approaches.

The model-based approaches suffer from difficulties in feature extraction under harsh lighting conditions, including significant shadowing and specularities. Furthermore, simple parts do not contain a large number of detectable features, which degrades the accuracy of a model-based fit to noisy image data.

The appearance-based approaches have no knowledge of the underlying 3D structure of the object, merely knowledge of 2D images of the object. These approaches have problems in segmenting out the object for recognition, have trouble with occlusions, and may not provide a 3D pose accurate enough for grasping purposes.

Approaches that use 3D data for recognition have somewhat different issues. Lighting effects cause problems for stereo reconstruction, and specularities can create spurious data both for stereo and laser range finders. Once the 3D data is generated, there are the issues of segmentation and representation. On the representation side, more complex models are often used than in the 2D case (e.g., superquadrics). These models contain a larger number of free parameters, which can be difficult to fit to noisy data.

Assuming that a part can be located, it must be picked up by the robot. The current standard for motion trajectories leading up to the grasping of an identified part is known as image based visual serving (IBVS). A key problem for IBVS is that image based servo systems control image error, but do not explicitly consider the physical camera trajectory. Image error results when image trajectories cross near the center of the visual field (i.e., requiring a large scale rotation of the camera). The conditioning of the image Jacobian results in a phenomenon known as camera retreat. Namely, the robot is also required to move the camera back and forth along the optical axis direction over a large distance, possibly exceeding the robot range of motion. Hybrid approaches decompose the robot motion into translational and rotational components either through identifying homeographic relationships between sets of images, which is computationally expensive, or through a simplified approach which separates out the optical axis motion. The more simplified hybrid approaches introduce a second key problem for visual serving, which is the need to keep features within the image plane as the robot moves.

Conventional bin picking systems are relatively deficient in at least one of the following: robustness, accuracy, and speed. Robustness is required since there may be no cost savings to the manufacturer if the error rate of correctly picking an object from a bin is not close to zero (as the picking station will still need to be manned). Location accuracy is necessary so that the grasping operation will not fail. And finally, solutions which take more than about 10 seconds between picks would slow down entire production lines, and would not be cost effective.

### BRIEF SUMMARY

A system and method for identifying objects using a robotic system are disclosed. Briefly described, in one aspect, an embodiment may be summarized as a method that captures an image of at least one object with an image capture device that is moveable with respect to the object, processes the captured image to identify at least one feature of the at least one object, and determines a hypothesis based upon the identified feature. By hypothesis, we mean a correspondence hypothesis between (a) an image feature and (b) a feature from a 3D object model, that could have given rise to the image feature.

In another aspect, an embodiment may be summarized as a robotic system that identifies objects comprising an image capture device mounted for movement with respect to a plurality of objects to capture images and a processing system communicatively coupled to the image capture device. The processing system is operable to receive a plurality of images captured by the image captive device, identify at least one feature for at least two of the objects in the captured images, determine at least one hypothesis predicting a pose for the at least two objects based upon the identified feature, determine a confidence level for each of the hypotheses, and select the hypothesis with the greatest confidence level.

In another aspect, an embodiment may be summarized as a method that captures a first image of at least one object with an image capture device that is moveable with respect to the object; determines a first hypothesis based upon at least one feature identified in the first image, wherein the first hypothesis is predictive of a pose of the feature; captures a second image of the at least one object after a movement of the image capture device; determines a second hypothesis based upon the identified feature, wherein the second hypothesis is predictive of the pose of the feature; and compares the first hypothesis with the second hypothesis.

In another aspect, an embodiment may be summarized as a method that captures an image of a plurality of objects, processes the captured image to identify a feature associated with at least two of the objects visible in the captured image, determines a hypothesis for the at least two visible objects based upon the identified feature, determines a confidence level for each of the hypotheses for the at least two visible objects, and selects the hypotheses with the greatest confidence level.

In another aspect, an embodiment may be summarized as a method that captures a first image of at least one object with an image capture device that is moveable with respect to the object, determines a first pose of at least one feature of the object from the captured first image, determines a hypothesis that predicts a predicted pose of the feature based upon the determined first pose, captures a second image of the object, determines a second pose of the feature from the captured second image, and updates the hypothesis based upon the determined second pose.

In another aspect, an embodiment may be summarized as a method that captures a first image of at least one object with an image capture device that is moveable with respect to the object, determines a first view of at least one feature of the object from the captured first image, determines a first hypothesis based upon the first view that predicts a first possible orientation of the object, determines a second hypothesis based upon the first view that predicts a second possible orientation of the object, moves the image capture device, captures a second image of the object, determines a second view of the at least one feature of the object from the captured second image, determines an orientation of a second view of the at least one feature, and compares the orientation of the second view with the first possible orientation of the object and the second possible orientation of the object, in order to determine which orientation is the correct one.

### BRIEF DESCRIPTION OF THE SEVERAL VIEWS OF THE DRAWING(S)

In the drawings, identical reference numbers identify similar elements or acts. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

FIG. 1 is an isometric view of a robot system according to one illustrated embodiment.

FIG. 2 is a block diagram illustrating an exemplary embodiment of the robot control system of FIG. 1.

FIG. 3A represents a first captured image of two objects each having a circular feature thereon.

FIG. 3B is a graphical representation of two identical detected ellipses determined from the identified circular features of FIG. 3A.

FIG. 3C represents a second captured image of the two objects of FIG. 3A that is captured after movement of the image capture device.

FIG. 3D is a second graphical representation of two detected ellipses determined form the identified circular features of FIG. 3C.

FIG. 4A is a captured image of a single lag screw.

FIG. 4B is a graphical representation of an identified feature, corresponding to the shaft of the lag screw of FIG. 4A, determined by the processing of the captured image of FIG. 4A.

FIG. 4C is a graphical representation of the identified feature after image processing has been reduced to the identified feature of the lag screw of FIG. 4A.

FIG. 5A is a first captured image of five lag screws.

FIG. 5B is a graphical representation of identified feature of the five lag screws determined by the processing of the captured image of FIG. 5A.

FIG. 5C is a graphical representation of the five identified features of FIG. 5B that after image processing has reduced a first captured image to the identified features.

FIG. 5D is a graphical representation of the five identified features after processing a subsequent captured image.

FIGS. 6-10 are flow charts illustrating various embodiments of a process for identifying objects.

### DETAILED DESCRIPTION

In the following description, certain specific details are set forth in order to provide a thorough understanding of various embodiments. However, one skilled in the art will understand that the invention may be practiced without these details. In other instances, well-known structures associated with robotic systems have not been shown or described in detail to avoid unnecessarily obscuring descriptions of the embodiments.

Unless the context requires otherwise, throughout the specification and claims which follow, the word “comprise” and variations thereof, such as, “comprises” and “comprising” are to be construed in an open sense, that is as “including, but not limited to.”

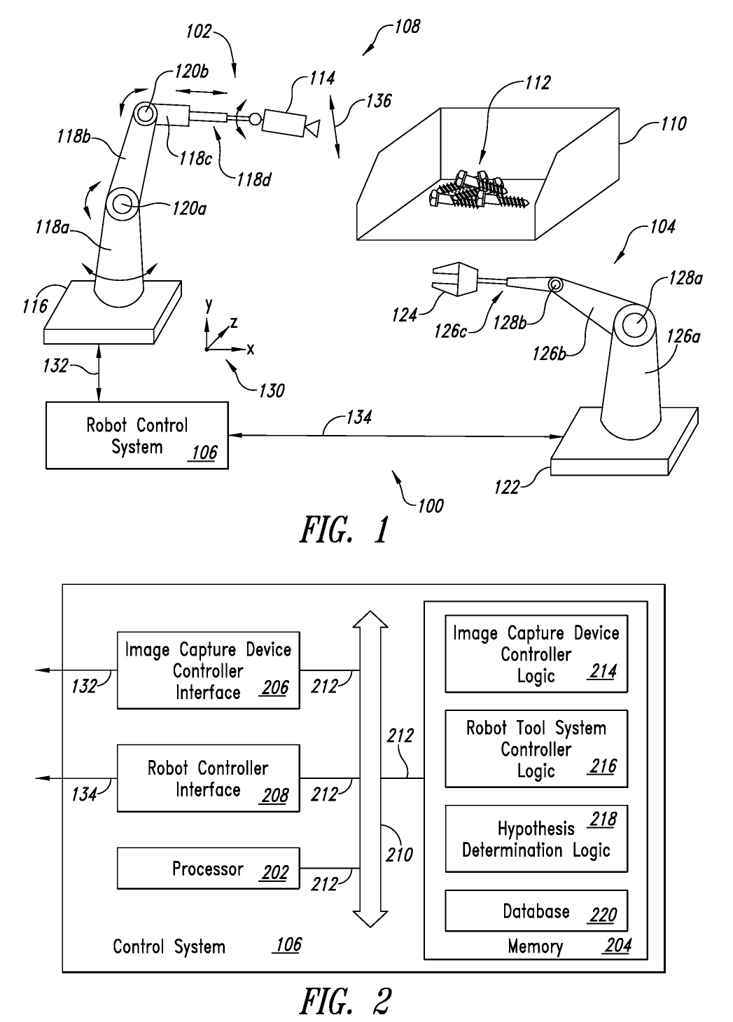

FIG. 1 is an isometric view of an object identification system 100 according to one illustrated embodiment. The illustrated embodiment of object identification system 100 comprises a robot camera system 102, a robot tool system 104, and a control system 106. The object identification system 100 is illustrated in a work environment 108 that includes a bin 110 or other suitable container having a pile of objects 112 therein. The object identification system 100 is configured to identify at least one of the objects in the pile of objects 112 to determine the pose (position and/or orientation) of the identified object. Once the pose of the object is determined, a work piece may perform an operation on the object, such as grasping the identified object. Generally, the above-described system may be referred to as a robotic system.

The illustrated embodiment of the robot camera system 102 comprises an image capture device 114, a base 116, and a plurality of robot camera system members 118. A plurality of servomotors and other suitable actuators (not shown) of the robot camera system 102 are operable to move the various members 118. In some embodiments, base 116 may be moveable. Accordingly, the image capture device 114 may be positioned and/or oriented in any desirable pose to capture images of the pile of objects 112.

In the exemplary robot camera system 102, member 118a is configured to rotate about an axis perpendicular to base 116, as indicated by the directional arrows about member 118a. Member 118b is coupled to member 118a via joint 120a such that member 118b is rotatable about the joint 120a, as indicated by the directional arrows about joint 120a. Similarly, member 118c is coupled to member 118b via joint 120b to provide additional rotational movement. Member 118d is coupled to member 118c. Member 118c is illustrated for convenience as a telescoping type member that may be extended or retracted to adjust the pose of the image capture device 114.

Image capture device 114 is illustrated as physically coupled to member 118c. Accordingly, it is appreciated that the robot camera system 102 may provide a sufficient number of degrees of freedom of movement to the image capture device 114 such that the image capture device 114 may capture images of the pile of objects 112 from any pose (position and/or orientation) of interest. It is appreciated that the exemplary embodiment of the robot camera system 102 may be comprised of fewer, of more, and/or of different types of members such that any desirable range of rotational and/or translational movement of the image capture device 114 may be provided.

Robot tool system 104 comprises a base 122, an end effector 124, and a plurality of members 126. End effector 124 is illustrated for convenience as a grasping device operable to grasp a selected one of the objects from the pile of objects 112. Any suitable end effector device(s) may be automatically controlled by the robot tool system 104.

In the exemplary robot tool system 104, member 126a is configured to rotate about an axis perpendicular to base 122. Member 126b is coupled to member 126a via joint 128a such that member 126b is rotatable about the joint 128a. Similarly, member 126c is coupled to member 126b via joint 128b to provide additional rotational movement. Also, member 126c is illustrated for convenience as a telescoping type member that may extend or retract the end effector 124.

Pose of the various components of the robot camera system 100 described above is known. Control system 106 receives information from the various actuators indicating position and/or orientation of the members 118, 126. When the information is correlated with a reference coordinate system 130, control system 106 may computationally determine pose (position and orientation) of every member 118, 126 such that position and orientation of the image capture device 114 and the end effector 124 is determinable with respect to a reference coordinate system 130. Any suitable position and orientation determination methods and system may be used by the various embodiments. Further, the reference coordinate system 130 is illustrated for convenience as a Cartesian coordinate system using an x-axis, an y-axis, and a z-axis. Alternative embodiments may employ other reference systems.

FIG. 2 is a block diagram illustrating an exemplary embodiment of the control system 106 of FIG. 1. Control system 106 comprises a processor 202, a memory 204, an image capture device controller interface 206, and a robot tool system controller interface 208. For convenience, processor 202, memory 204, and interfaces 206, 208 are illustrated as communicatively coupled to each other via communication bus 210 and connections 212, thereby providing connectivity between the above-described components. In alternative embodiments of the control system 106, the above-described components may be communicatively coupled in a different manner than illustrated in FIG. 2. For example, one or more of the above-described components may be directly coupled to other components, or may be coupled to each other, via intermediary components (not shown). In some embodiments, communication bus 210 is omitted and the components are coupled directly to each other using suitable connections.

Image capture device controller logic 214, residing in memory 204, is retrieved and executed by processor 202 to determine control instructions for the robot camera system 102 such that the image capture device 114 may be positioned and/or oriented in a desired pose to capture images of the pile of objects 112 (FIG. 1). Control instructions are communicated from processor 202 to the image capture device controller interface 206 such that the control signals may be properly formatted for communication to the robot camera system 102. Image capture device controller interface 206 is communicatively coupled to the robot camera system 102 via connection 132. For convenience, connection 132 is illustrated as a hardwire connection. However, in alternative embodiments, the control system 106 may communicate control instructions to the robot camera system 102 using alternative communication media, such as, but not limited to, radio frequency (RF) media, optical media, fiber optic media, or any other suitable communication media. In other embodiments, image capture device controller interface 206 is omitted such that another component or processor 202 communicates command signals directly to the robot camera system 102.

Similarly, robot tool system controller logic 216, residing in memory 204, is retrieved and executed by processor 202 to determine control instructions for the robot tool system 104 such that the end effector 124 may be positioned and/or oriented in a desired pose to perform a work operation on an identified object in the pile of objects 112 (FIG. 1). Control instructions are communicated from processor 202 to the robot tool system controller interface 208 such that movement command signals may be properly formatted for communication to the robot tool system 104. Robot tool system controller interface 208 is communicatively coupled to the robot tool system 104 via connection 134. For convenience, connection 134 is illustrated as a hardwire connection. However, in alternative embodiments, the control system 106 may communicate control instructions to the robot tool system 104 using alternative communication media, such as, but not limited to, radio frequency (RF) media, optical media, fiber optic media, or any other suitable communication media. In other embodiments, robot tool system controller interface 208 is omitted such that another component or processor 202 communicates command signals directly to the robot tool system 104.

The hypothesis determination logic 218 resides in memory 204. As described in greater detail hereinbelow, the various embodiments determine the pose (position and/or orientation) of an object using the hypothesis determination logic 218, which is retrieved from memory 204 and executed by processor 202. The hypothesis determination logic 218 contains at least instructions for processing a captured image, instructions for determining a hypothesis, instructions for hypothesis testing, instructions for determining a confidence level for a hypothesis, instructions for comparing the confidence level with a threshold(s), and instructions for determining pose of an object upon validation of a hypothesis. Other instructions may also be included in the hypothesis determination logic 218, depending upon the particular embodiment. By hypothesis, we mean a correspondence hypothesis between (a) an image feature and (b) a feature from a 3D object model, that could have given rise to the image feature.

Database 220 resides in memory 204. As described in greater detail hereinbelow, the various embodiments analyze captured image information to determine one or more features of interest on one or more of the objects in the pile of objects 112 (FIG. 1). Control system 106 computationally models the determined feature of interest, and then compares the determined feature of interest with a corresponding feature of interest of a model of a reference object. The comparison allows the control system 106 to determine at least one hypothesis pertaining to the pose of the object(s). The various embodiments use the hypothesis to ultimately determine the pose of at least one object, as described in greater detail below. Captured image information, various determined hypotheses, models of reference objects and other information is stored in the database 220.

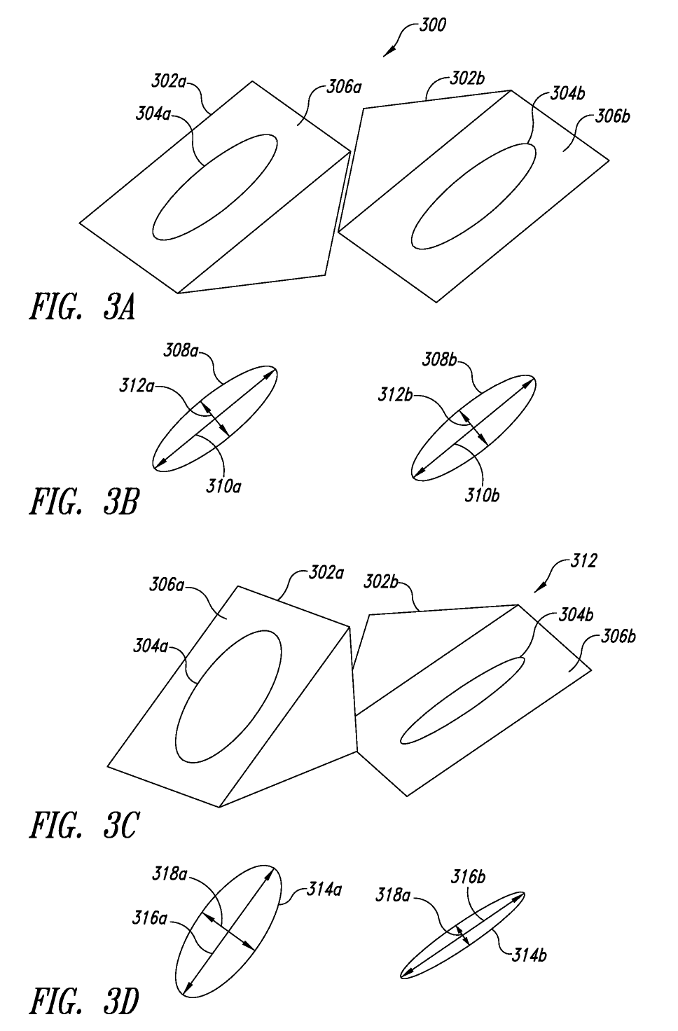

Operation of an exemplary embodiment of the object identification system 100 will now be described in greater detail. Processor 202 determines control instructions for the robot camera system 102 such that the image capture device 114 is positioned and/or oriented to capture a first image of the pile of objects 112 (FIG. 1). The image capture device 114 captures a first image of the pile of objects 112 and communicates the image data to the control system 106. The first captured image is processed to identify at least one feature of at least one of the objects in the pile of objects 112. Based upon the identified feature, a first hypothesis is determined. Identification of a feature of interest and the subsequent hypothesis determination is described in greater detail below and illustrated in FIGS. 3A-D. If the feature is identified on multiple objects, a hypothesis for each object is determined. If the feature is identified multiple times on the same object, multiple hypotheses for that object are determined.

FIG. 3A represents a first captured image 300 of two objects 302a, 302b each having a feature 304 thereon. The objects 302a, 302b are representative of two simple objects that have a limited number of detectable features. Here, the feature 304 is the detectable feature of interest. The feature 304 may be a round hole through the object 302, may be a groove or slot cut into the surface 306 of the object 302, may be a round protrusion from the surface 306 of the object 302, or may be a painted circle on the surface 306 of the object. For the purposes of this simplified example, the feature 304 is understood to be circular (round). Because the image capture device 114 is not oriented perpendicular to either of the surfaces 306a, 306b of the objects 302a, 302b, it is appreciated that a perspective view of the circular features 304a, 304b will appear as ellipses.

The control system 106 processes a series of captured images of the two objects 302. Using a suitable edge detection algorithm or the like, the robot control system 106 determines a model for the geometry of at least one of the circular features 304. For convenience, this simplified example assumes that geometry models for both of the features 304 are determined since the feature 304 is visible on both objects 302.

FIG. 3B is a graphical representation of two identical detected ellipses 308a, 308b determined from the identified circular features 304a, 304b of FIG. 3A. That is, the captured image 300 has been analyzed to detect the feature 304a of object 302a, thereby determining a geometry model of the detected feature 304a (represented graphically as ellipse 308a in FIG. 3B). Similarly, the captured image 300 has been analyzed to detect the feature 304b of object 302b, thereby determining a geometry model of the detected feature 304b (represented graphically as ellipse 308b in FIG. 3B). It is appreciated that the geometry models of the ellipses 308a and 308b are preferably stored as mathematical models using suitable equations and/or vector representations. For example, ellipse 308a may be modeled by its major axis 310a and minor axis 312a. Ellipse 308b may be modeled by its major axis 310b and minor axis 312b. It is appreciated that the two determined geometries of the ellipses 308a, 308b are identical in this simplified example because the perspective view of the features 304a and 304b is the same. Accordingly, equations and/or vectors modeling the two ellipses 308a, 308b are identical.

From the determined geometry models of the ellipses (graphically illustrated as ellipses 308a, 308b in FIG. 3B), it is further appreciated that the pose of either object 302a or 302b is, at this point in the image analysis process, indeterminable from the single capture image 300 since at least two possible poses for an object are determinable based upon the detected ellipses 308a, 308b. That is, because the determined geometry models of the ellipses (graphically illustrated as ellipses 308a, 308b in FIG. 3B) are the same given the identical view of the circular features 304a, 304b in the captured image 300, object pose cannot be determined. This problem of indeterminate object pose may be referred to in the arts as a two-fold redundancy. In alternative embodiments, a second image capture device may be used to provide stereo information to more quickly resolve two-fold redundancies, although such stereo imaging may suffer from the aforementioned problems.

In one embodiment, a hypothesis pertaining to at least object pose is then determined for a selected object. In other embodiments, a plurality of hypotheses are determined, one or more for each object having a visible feature of interest. A hypothesis is based in part upon a known model of the object, and more particularly, a model of its corresponding feature of interest. To determine a hypothesis, geometry of the feature of interest determined from a captured image is compared against known model geometries of the reference feature of the reference object to determine at least one predicted aspect of the object, such as the pose of the object. That is, a difference is determined between the identified feature and a reference feature of a known model of the object. Then, the hypothesis may be based at least in part upon the difference between the identified feature and the reference feature once the geometry of a feature is determined from a captured image. In another embodiment, the known model geometry is adjusted until a match is found between the determined feature geometry and the reference model. Then, the object's pose or orientation may be hypothesized for the object.

In other embodiments, the hypothesis pertaining to object pose is determined based upon detection of multiple features of interest. Thus, the first captured image or another image may be processed to identify a second feature of the object. Accordingly, the hypothesis is based at least in part upon the difference between the identified second feature and the second reference feature. In some embodiments, a plurality of hypotheses are determined based upon the plurality of features of interest.

In the above simplified example where the feature of interest for the objects 302a, 302b is circular, various perspective views of a circular feature are evaluated at various different geometries (positions and/or orientations) until a match is determined between the detected feature and the known model feature. In the above-described simplified example, the model geometry of a perspective view of a circular reference feature is compared with one or more of the determined geometries of the ellipses 308a, 308b. It is appreciated from FIG. 3A, that once a match is made between the feature geometry of a reference model and a feature geometry determined from a captured image, one of at least two different poses (positions and/or orientations) are possible for the objects 302a, 302b.

As noted above, pose of the image capture device 114 at the point where each image is captured is known with respect to coordinate system 130. Accordingly, the determined hypothesis can be further used to predict one or more possible poses for an object in space with reference to the coordinate system 130 (FIG. 1).

Because object pose is typically indeterminable from the first captured image, another image is captured and analyzed. Changes in the detected feature of interest in the second captured image may be compared with the hypothesis to resolve the pose question described above. Accordingly, the image capture device 114 (FIG. 1) is moved to capture of a second image from a different perspective. (Alternatively, the objects could be moved, such as when the bin 110 is being transported along an assembly line or the like.)

In selected embodiments, the image capture device 114 is dynamically moved in a direction and/or dynamically moved to a position as described herein. In other embodiments, the image capture device 114 is moved in a predetermined direction and/or to a predetermined position. In other embodiments, the objects are moved in a predetermined direction and/or to a predetermined position. Other embodiments may use a second image capture device and correlate captured images to resolve the above-described indeterminate object pose problem.

In yet other embodiments, the determined hypothesis is further used to determine a path of movement for the image capture device, illustrated by the directional arrow 136 (FIG. 1). The image capture device 114 is moved some incremental distance along the determined path of movement. In another embodiment, the hypothesis is used to determine a second position (and/or orientation) for the image capture device 114. When a second image is subsequently captured, the feature of interest (here the circular features 304a, 304b) of a selected one of the objects 302a or 302b will be detectable at a different perspective.

In some situations, detected features of interest will become more or less discernable for the selected object in the next captured image. For example, in the event that the hypothesis correctly predicts pose of the object, the feature of interest may become more discernable in the second captured image if the image capture device is moved in a direction that is predicted to improve the view of the selected object. In such situations, the detected features of interest will be found in the second captured image where predicted by the hypothesis in the event that the hypothesis correctly predicts pose of the object. If the hypothesis is not valid, the detected feature of interest will be in a different place in the second captured image.

FIG. 3C represents a second captured image 312 of the two objects 302a, 302b of FIG. 3A that is captured after the above-described movement of the image capture device 114 (FIG. 1) along a determined path of movement. The second captured image 312 is analyzed to again detect the circular feature 304a of object 302a, thereby determining a second geometry model of the detected circular feature 304a, represented graphically as the ellipse 314a in FIG. 3D. Similarly, the second captured image 312 is analyzed to detect the circular feature 304b of object 302b, thereby determining a second geometry model of the detected circular feature 304b, represented graphically as the ellipse 314b in FIG. 3D. It is appreciated that the geometry models of the ellipses 314a and 314b are preferably stored as mathematical models using suitable equations (e.g., b-splines or the like) and/or vector representations. For example, ellipse 314a may be modeled by its major axis 316a and minor axis 318a. Similarly, ellipse 314b may be modeled by its major axis 316b and minor axis 318b. Because the image capture device 114 is not oriented perpendicular to the surface 306 of either object 302a or 302b, it is appreciated that a perspective view of the circular features 304a and 304b will again appear as ellipses.

From the determined geometry models of the ellipses (graphically illustrated as ellipses 308a, 308b in FIG. 3B), it is appreciated that the orientation of objects 302a and 302b has changed relative to the image capture device 114. The illustrated ellipse 314a has become wider (compared to ellipse 308a in FIG. 3B) and the illustrated ellipse 314b has become narrower (compared to ellipse 308b in FIG. 3B). Also, orientation of the ellipses 314a, 314b have changed. That is, the determined geometry models of the ellipses 314a, 314b will now be different because the view of the circular features 304a, 304b in the captured image 312 has changed (from the previous view in the captured image 302).

The initial hypothesis determined from the first captured image may be used to predict the expected geometry models of the ellipses (graphically illustrated as ellipses 314a, 314b in FIG. 3D) in the second captured image based upon the known movement of the image capture device 114. That is, given a known movement of the image capture device 114, and given a known (but approximate) position of the objects 302a, 302b, the initial hypothesis may be used to predict expected geometry models of at least one of the ellipses identified in the second captured image (graphically illustrated as ellipses 314a and/or 314b in FIG. 3D).

In one exemplary embodiment, the identified feature in the second captured image is compared with the hypothesis to determine a first confidence level of the first hypothesis. If the first confidence level is at least equal to a threshold, the hypothesis may be validated. A confidence value may be determined which mathematically represents the comparison. Any suitable comparison process and/or type of confidence value may be used by various embodiments. For example, but not limited to, a determined orientation of the feature may be compared to a predicted orientation the feature based upon the hypothesis and the known movement of the image capture device relative to the object to compute a confidence value. Thus, a difference in actual orientation and predicted orientation could be compared with a threshold.

For example, returning to FIGS. 3C and 3D, the ellipses 314a and 314b correspond to orientation of the circular feature of interest 304 on the objects 302a, 302b (as modeled by their respective major axis and minor axis). The geometry of ellipses 314a and 314b may be compared with a predicted ellipse geometry determined from the current hypothesis. Assume that the threshold confidence value requires that a geometry of the selected feature of interest in the captured image be within a threshold confidence value. This predicted geometry would be based upon the hypothesis and the known image capture device movement (or object movement). If the geometry of the ellipse 314a in the captured image was equivalent to or within the threshold, then that hypothesis would be determined to be valid.

Other confidence levels could be employed to invalidate a hypothesis. For example, a second threshold confidence value could require that a geometry of the area of the selected feature of interest in the captured image be less than a second threshold. If the geometry of the feature of interest in the captured image was outside the second threshold, then that hypothesis would be determined to be invalid.

It is appreciated that a variety of aspects of a feature of interest could be selected to determine a confidence level or value. Vector analysis is another non-limiting example, where the length and angle of the vector associated with a feature of interest on a captured image could be compared with a predicted length and angle of a vector based upon a hypothesis.

In some embodiments, the same feature on a plurality of objects may be used to determine a plurality of hypotheses for the feature of interest. The plurality of hypotheses are compared with corresponding reference model feature, and a confidence value or level is determined for each hypothesis. Then, one of the hypotheses having the highest confidence level and/or the highest confidence value could be selected to identify an object of interest for further analysis. The identified object may be the object that is targeted for picking from the bin 110 (FIG. 1), for example. After selection based upon hypothesis validation, a determination of the object's position and/or pose is made. It is appreciated that other embodiments may use any of the various hypotheses determination and/or analysis processes described herein.

In an alternative embodiment, a hypothesis may be determined for the feature of interest in each captured image, where the hypothesis is predictive of object pose. The determined hypotheses between images may be compared to verify pose of the feature. That is, when the pose hypothesis matches between successively captured images, the object pose may then be determinable.

As noted above, movement of the image capture device 114 is known. In this simplified example, assume that the predicted geometry of the circular feature on a reference model is an ellipse that is expected to correspond to the illustrated ellipse 314a in FIG. 3D. Comparing the two determined geometry models of the ellipses 314a, 314b, the pose of object 302a (based upon analysis of the illustrated ellipse 314a in FIG. 3D) will match or closely approximate the predicted pose of the reference model. Accordingly, the object identification system 100 will understand that the object 302a has a detected feature that matches or closely approximates the predicted geometry of the reference feature given the known motion of the image capture device 114. Further, the object identification system 100 will understand that the object 302b has a detected feature that does not match or closely approximate the predicted pose of the reference model.

The process of moving the image capture device 114 incrementally along the determined path continues until the pose of one at least one of the objects is determinable. In various embodiments, the path of movement can be determined for each captured image based upon the detected features in that captured image. That is, the direction of movement of the image capture device 114, or a change in pose for the image capture device 114, may be dynamically determined. Also, the amount of movement may be the same for each incremental movement, or the amount of movement may vary between capture of subsequent images.

In another exemplary embodiment, a plurality of different possible hypotheses are determined for the visible feature of interest for at least one object. For example, a first hypothesis could be determined based upon a possible first orientation and/or position of the identified feature. A second hypothesis could be determined based upon a possible second orientation and/or position of the same identified feature.

Returning to FIG. 3b, assume that object 306a was selected for analysis. The image of the feature 304a corresponds to the ellipse 308a. However, there are two possible poses apparent from FIG. 3A for an object having the detected feature corresponding to the ellipse 308a. The first possible pose would be as shown for the object 302a. The second possible pose would be as shown for the object 302b. Since there are two possible poses, a first hypothesis would be determined for a pose corresponding to the pose of object 302a, and a second hypothesis would be determined for a pose corresponding to the pose of object 302b.

When the second captured image is analyzed, the two hypotheses are compared with a predicted pose (orientation and/or position) of the feature of interest. The hypotheses that fails to match or correspond to the view of detected feature would be eliminated.

Returning to FIG. 3D, assuming that the image capture device 114 (FIG. 1) was moved in an upward direction and to the left, the predicted pose of the feature of interest (feature 304a) would correspond to the ellipse 314a illustrated in FIG. 3D. The first hypothesis, which corresponds to the pose of object 302a (FIG. 3C), would predict that the image of the selected feature would result in the ellipse 314a. The second hypothesis, which corresponds to the pose of object 302b (FIG. 3C), would predict that the image of the selected feature would result in the ellipse 314b. Since, after capture of the second image, the feature of interest exhibited a pose corresponding to the ellipse 314a, and not the ellipse 314b, the second hypothesis would be invalidated.

It is appreciated that the above-described approach of determining a plurality of possible hypotheses from the first captured image, and then eliminating hypotheses that are inconsistent with the feature of interest in subsequent captured images, may be advantageously used for objects having a feature of interest that could be initially characterized by many possible poses. Also, this process may be advantageous for an object having two or more different features of interest such that families of hypothesis are developed for the plurality of different features of interest.

At some point in the hypothesis elimination process for a given object, only one hypothesis (or family of hypotheses) will remain. The remaining hypothesis (or family of hypotheses) could be tested as described herein, and if validated, the object's position and/or pose could then be determined.

Furthermore, the above-described approach is applicable to a plurality of objects having different poses, such as the jumbled pile of objects 112 illustrated in FIG. 1. Two or more of the objects may be identified for analysis. One or more features of each identified object could be evaluated to determine a plurality of possible hypotheses for each feature. The pose could be determined for any object whose series of hypotheses (or family of hypotheses) are first reduced to a single hypothesis (or family of hypotheses).

Such a plurality of hypotheses may be considered in the aggregate or totality, referred to as a signature. The signature may correspond to hypotheses developed for any number of characteristics or features of interest of the object. For example, insufficient information from one or more features of interest may not, by themselves, be sufficient to develop a hypothesis and/or predict pose of the object. However, when considered together, there may be sufficient information to develop a hypothesis and/or predict pose of the object.

For convenience of explaining operation of one exemplary embodiment, the above-described example (see FIGS. 3A-3C) determined only one feature of interest (the circular feature) for two objects (302a and 302b). It is appreciated that the above-described simplified example was limited to two objects 302a, 302b. When a large number of objects are in the pile of objects 112 (FIG. 1), a plurality of visible object features are detected. That is, an edge detection algorithm detects a feature of interest for a plurality of objects. Further, it is likely that there will also be false detections of other edges and artifacts which might be incorrectly assumed to be the feature of interest.

Accordingly, the detected features (whether true detection of a feature of interest or a false detection of other edges or artifacts) are analyzed to initially identify a plurality of most-likely detected features. If a sufficient number of features are not initially detected, subsequent images may be captured and processed after movement of the image capture device 114. Any suitable system or method of initially screening and/or parsing an initial group of detected edges into a plurality of most-likely detected features of interest may be used by the various embodiments. Accordingly, such systems and method are not described in detail herein for brevity.

Once the plurality of most-likely detected features of interest are initially identified, the image capture device 114 is moved and the subsequent image is captured. Because real-time processing of the image data is occurring, and because the incremental distance that the image capture device 114 is moved is relatively small, the embodiments may base subsequent edge detection calculations on the assumption that the motion of the plurality of most-likely detected features from image to image should be relatively small. Processing may be limited to the identified features of interest, and other features may be ignored. Accordingly, relatively fast and efficient edge detection algorithms may be used to determine changes in the plurality of identified features of interest.

In other embodiments, one detected feature of interest (corresponding to one of the objects in the pile of objects 112) is selected for further edge detection processing in subsequently captured images. That is, one of the objects may be selected for tracking in subsequently captured images. Selection of one object may be based on a variety of considerations. For example, one of the detected features may correlate well with the reference model and may be relatively “high” in its position (i.e., height off of the ground) relative to other detected features, thereby indicating that the object associated with the selected feature of interest is likely on the top of the pile of objects 112. Or, one of the detected features may have a relatively high confidence level with the reference model and may not be occluded by other detected features, thereby indicating that the object associated with the selected feature of interest is likely near the edge of the pile of objects 112. In other embodiments, a selected number of features of interest may be analyzed.

Once the second captured image has been analyzed to determine changes in view of the feature(s) of interest, the hypothesis may be validated. That is, a confidence level or value is determined based upon the hypothesis and the detected feature. The confidence level or value corresponds to a difference between the detected feature and a prediction of the detected feature (which is made with the model of the reference object based upon the current hypothesis). If the confidence level or value for the selected feature is equal to at least some threshold value, a determination is made that the pose of the object associated with the selected feature can be determined.

Returning to the simplified example described above (see FIGS. 3A-3C), assume that the ellipse 314a is selected for correlation with the model of the reference object. If a confidence level or value derived from the current hypothesis is at least equal to a threshold, then the equation of the ellipse 314a, and/or the vectors 316a and 318a, may be used to determine the pose of the circular feature 304a (with respect to the reference coordinate system 130 illustrated in FIG. 1). Upon determination of the pose of the circular feature 304a, the corresponding pose of the object 302a is determinable to within 1 degree of freedom, i.e., rotation about the circle center. (Alternatively, the pose of the object 302a may be directly determinable from the equation of the ellipse 314a and/or the vectors 316a.) Any suitable system or method of determining pose of an object may be used by the various embodiments. Accordingly, such systems and method are not described in detail herein for brevity.

On the other hand, the confidence level or value may be less than the threshold, less than a second threshold, or less than the first threshold by some predetermined amount, such that a determination is made that the hypothesis is invalid. Accordingly, the invalid hypothesis may be rejected, discarded or the like. The process of capturing another first image and determining another first hypothesis would be restarted. Alternatively, if captured image data is stored in memory 204 (FIG. 1) or in another suitable memory, the original first image could be re-analyzed such that the feature of interest on a different object, or a different feature of interest on the same object, could be used to determine one or more hypotheses.

Assuming that the current hypothesis is neither validated or invalidated, a series of subsequent images are captured. Edge detection is used to further track changes in the selected feature(s) of interest in the subsequently captured images. At some point, a correlation will be made between the determined feature of interest and the corresponding feature of interest of the reference object such that the hypothesis is verified or rejected. That is, at some point in the process of moving the image capture device 114 (or moving the objects), and capturing a series of images which are analyzed by the control system 106 (FIG. 1), the hypothesis will be eventually verified. Then, the pose of the object may be determined.

Once the pose of the object is determined, control instructions may be determined such that the robot tool system 104 may be actuated to move the end effector 124 in proximity of the object such that the desired work may be performed on the object (such as grasping the object and removing it from the bin 110). On the other hand, at some point in the process of moving the image capture device 114 and capturing a series of images which are analyzed by the control system 106 (FIG. 1), the hypothesis may be invalidated such that the above-described process is started over with capture of another first image.

At some point in the process of capturing a series of images after movement of the image capture device 114 (or movement of the objects), a second hypothesis may be determined by alternative embodiments. For example, one exemplary embodiment determines a new hypothesis for each newly captured image. The previous hypothesis is discarded. Thus, for each captured image, the new hypothesis may be used to determine a confidence level or value to test the validity of the new hypothesis.

In other embodiments, the previous hypothesis may be updated or revised based upon the newly determined hypothesis. Non-limiting examples of updating or revising the current hypothesis include combining the first hypothesis with a subsequent hypothesis. Alternatively, the first hypothesis could be discarded and replaced with a subsequent hypothesis. Other processes of updating or revising a hypothesis may be used. Accordingly, the updated or revised hypothesis may be used to determine another confidence level to test the validity of the updated or revised hypothesis.

Any suitable system or method of hypothesis testing may be used by the various embodiments. For example, the above-described process of comparing areas or characteristics of vectors associated with the captured image of the feature of interest could be used for hypothesis testing. Accordingly, such hypothesis testing systems and method are not described in detail herein for brevity.

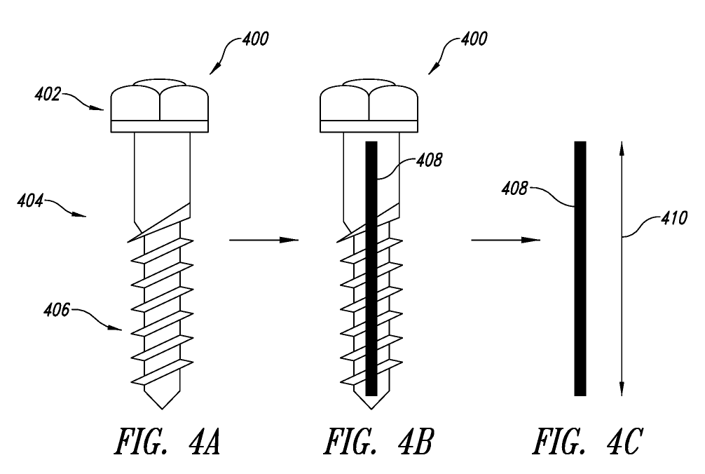

Another simplified example of identifying an object and determining its pose is provided below. FIG. 4A is a captured image of a single lag screw 400. Lag screws are bolts with sharp points and coarse threads designed to penetrate. Lag screw 400 comprises a bolt head 402, a shank 404, and a plurality of threads 406 residing on a portion of the shank 404. It is appreciated that the lag screw 404 is a relatively simple object that has relatively few detectable features that may be used to determine the pose of a single lag screw 400 by conventional robotic systems.

FIG. 4B is a graphical representation of an identified feature 408, corresponding to the shank 404 of the lag screw 400. The identified feature 408 is determined by processing the captured image of FIG. 4A. For convenience, the identified feature 408 is graphically illustrated as a vertical bar along the centerline and along the length of the shank 404. The identified feature 408 may be determined using any suitable detectable edges associated with the shank 404.

FIG. 4C is a graphical representation of the identified feature 408 after image processing has been reduced to the identified feature of the lag screw of FIG. 4A. It is appreciated that the identified feature 408 illustrated in FIG. 4C conceptually demonstrates that the lag screw 400 may be represented computationally by the identified feature 408. That is, a computational model of the lag screw 400 may be determined from the edge detection process described herein. The computational model may be as simple as a vector having a determinable orientation (illustrated vertically) and as having a length corresponding to the length of shank 404. It is appreciated that the edge detection process may detect other edges of different portions of the lag screw 400. FIG. 4C conceptually demonstrates that these other detected edges of other portions of the lag screw 400 may be eliminated, discarded or otherwise ignored such that only the determined feature 408 remains after image processing.

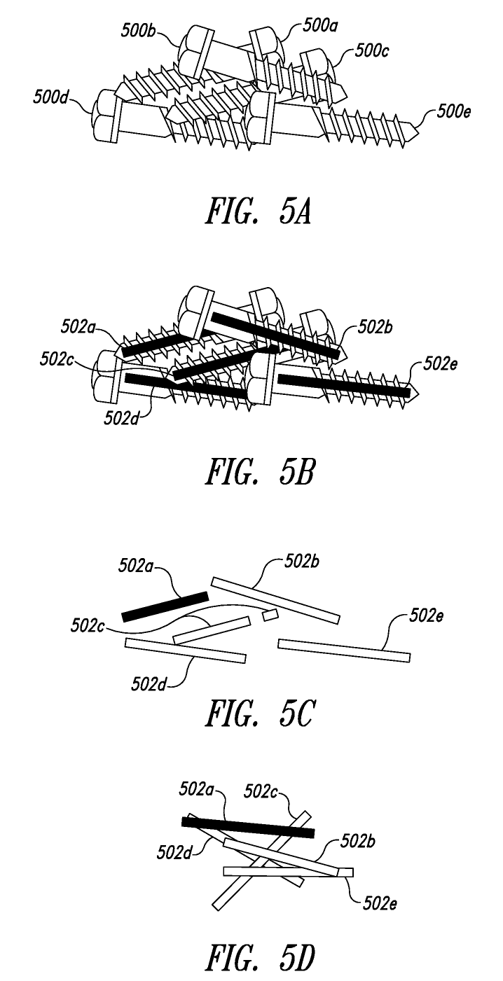

Continuing with the second example, FIG. 5A is a hypothetical first captured image of five lag screws 500a-e. Assume that the topmost lag screw 500a is the object whose pose will be identified in this simplified example. Accordingly, the lag screw 500a will be selected from the pile of lag screws 500a-e for an operation performed by the robot tool system 104 (FIG. 1). As noted above, lag screws 500a-e are relatively simple objects having few discernable features of interest that are detectable using an edge detection algorithm.

FIG. 5B is a graphical representation of identified feature of interest for the five lag screws. The features are determined by processing the captured image of FIG. 5A. For convenience, the identified features 502a-e associated with the five lag screws 500a-e, respectively, are graphically represented as bars. Because of occlusion of the lag screw 500a by lag screw 500b, it is appreciated that only a portion of the feature of interest associated with lag screw 500a will be identifiable in a captured image given the orientation of the image capture device 114. That is, the current image of FIG. 5A conceptually illustrates that an insufficient amount of a lag screw 500a may be visible for a reliable and accurate determination of the pose of the lag screw 500a.

FIG. 5C is a graphical representation of the five identified features of FIG. 5B after image processing has reduced a first captured image to the identified features. For convenience, the feature of interest of lag screw 500a (corresponding to the shank of lag screw 500a) is now graphically represented by the black bar 502a. Also for convenience, the identified features 502b-e associated with the other lag screws 500b-e are now graphically represented using white bars so that the features of these lag screws 500b-e may be easily differentiated from the feature of interest 502a of the lag screw 500a. It is apparent from the identified feature 502a of the lag screw 500a, that insufficient information is available to reliably and accurately determine the pose of the lag screw 500a.

In this simplified example of determining the pose of the lag screw 500a, it is assumed that the identified feature of interest 502a (graphically represented by the black bar) does not provide sufficient information to determine the pose of the lag screw 500a. That is, a hypothesis may be determined by comparing the feature of a reference model of a lag screw (the shank of a lag screw) with the determined feature 502a. However, because of the occlusion of a portion of the lag screw 500a by lag screw 500b, the length of the identified feature 502a will be less than the length of the feature in the absence of the occlusion. (On the other hand, an alternative hypothesis could assume that the lag screw 500a is at some angle in the captured image to account for the relatively short length of the identified feature 502a.)

In some embodiments the identified feature 502a and/or the other identified features 502b-e are used to determine movement of the image capture device 114 (FIG. 1) for capture of subsequent images. For example, because the identified features 502c and 502d are below the identified feature 502a, the control system 106 may determine that movement of the image capture device 114 should generally be in an upwards direction over the top of the pile of lag screws 502a-e. Furthermore, since the identified features 502b and 502e are to the right of the identified feature 502a, the control system 106 may determine that movement of the image capture device 114 should generally be towards the left of the pile of lag screws 502a-e.

FIG. 5D is a graphical representation of the five identified features after processing a subsequent image captured after movement of the image capture device 114. For the purposes of this simplified example, assume that a series of images have been captured such that the image capture device 114 (FIG. 1) is currently directly overhead and looking down onto the pile of lag screws 500a-e. After processing of an image captured with the image capture device 114 positioned and oriented as described above, the determined features 500a-e may be as illustrated in FIG. 5D. Accordingly, since the lag screw 500a will be visible without occlusions by the other lag screws 500b-e, the determined feature 502a in FIG. 5D may be sufficient for the control system 106 to accurately and reliably determine the pose of the lag screw 500a.

Here, the completely visible lag screw 500a will result in a determined feature 502a that substantially corresponds to the reference feature (the shank) of a reference model of a lag screw. Since the lag screw 500a is illustrated as laying in a slightly downward angle on the pile of lag screws 500a-e, the perspective view of the feature of the reference model will be adjusted to match up with the determined feature 502a. Accordingly, the pose of the lag screw 500a may be reliably and accurately determined. That is, given a hypothesis that the expected pose of a completely visible reference lag screw now reliably matches the determined feature 502a, the pose of the lag screw 500a is determinable.

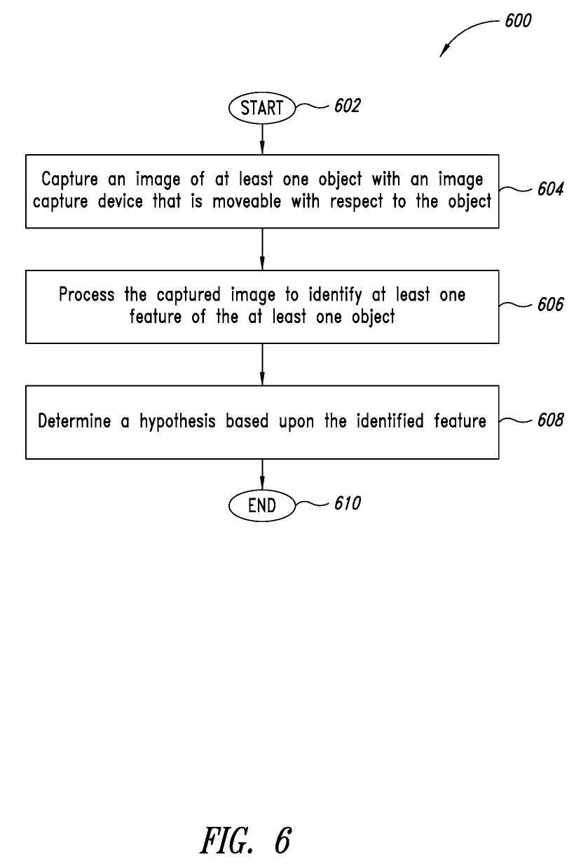

FIGS. 6-10 are flow charts 600, 700, 800, 900, and 1000, respectively, illustrating various embodiments of a process for identifying objects using a robotic system. The flow charts 600, 700, 800, 900, and 1000 show the architecture, functionality, and operation of various embodiments for implementing the logic 218 (FIG. 2) such that such that an object is identified. An alternative embodiment implements the logic of charts 600, 700, 800, 900, and 1000 with hardware configured as a state machine. In this regard, each block may represent a module, segment or portion of code, which comprises one or more executable instructions for implementing the specified logical function(s). It should also be noted that in alternative embodiments, the functions noted in the blocks may occur out of the order noted in FIGS. 6-10, or may include additional functions. For example, two blocks shown in succession in FIGS. 6-10 may in fact be substantially executed concurrently, the blocks may sometimes be executed in the reverse order, or some of the blocks may not be executed in all instances, depending upon the functionality involved, as will be further clarified hereinbelow. All such modifications and variations are intended to be included herein within the scope of this disclosure.

The process illustrated in FIG. 6 begins at block 602. At block 604, an image of at least one object is captured with an image capture device that is moveable with respect to the object. At block 606, the captured image is processed to identify at least one feature of the at least one object. At block 608, a hypothesis is determined based upon the identified feature. The process ends at block 610.

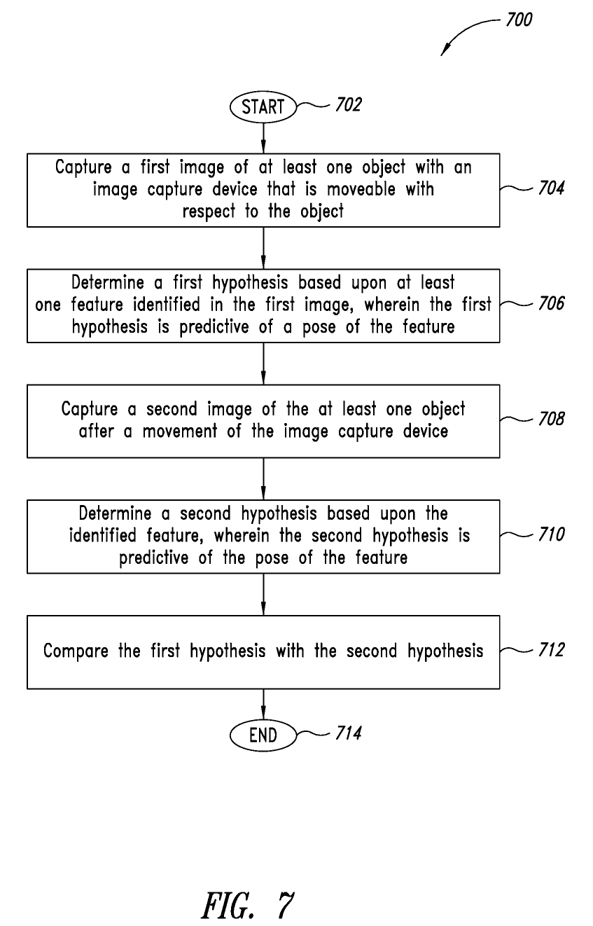

The process illustrated in FIG. 7 begins at block 702. At block 704, a first image of at least one object is captured with an image capture device that is moveable with respect to the object. At block 706, a first hypothesis is determined based upon at least one feature identified in the first image, wherein the first hypothesis is predictive of a pose of the feature. At block 708, a second image of the at least one object is captured after a movement of the image capture device. At block 710, a second hypothesis is determined based upon the identified feature, wherein the second hypothesis is predictive of the pose of the feature. At block 712, the first hypothesis is compared with the second hypothesis to verify pose of the feature. The process ends at block 714.

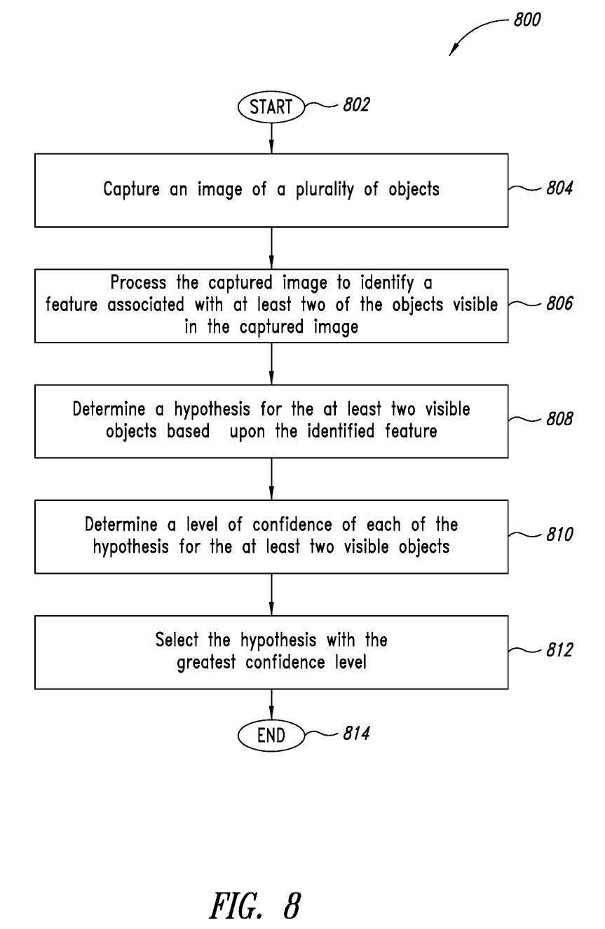

The process illustrated in FIG. 8 begins at block 802. At block 804, an image of a plurality of objects is captured. At block 806, the captured image is processed to identify a feature associated with at least two of the objects visible in the captured image. At block 808, a hypothesis is determined for the at least two visible objects based upon the identified feature. At block 810, a confidence level of each of the hypotheses is determined for the at least two visible objects. At block 812, the hypothesis with the greatest confidence level is selected. The process ends at block 814.

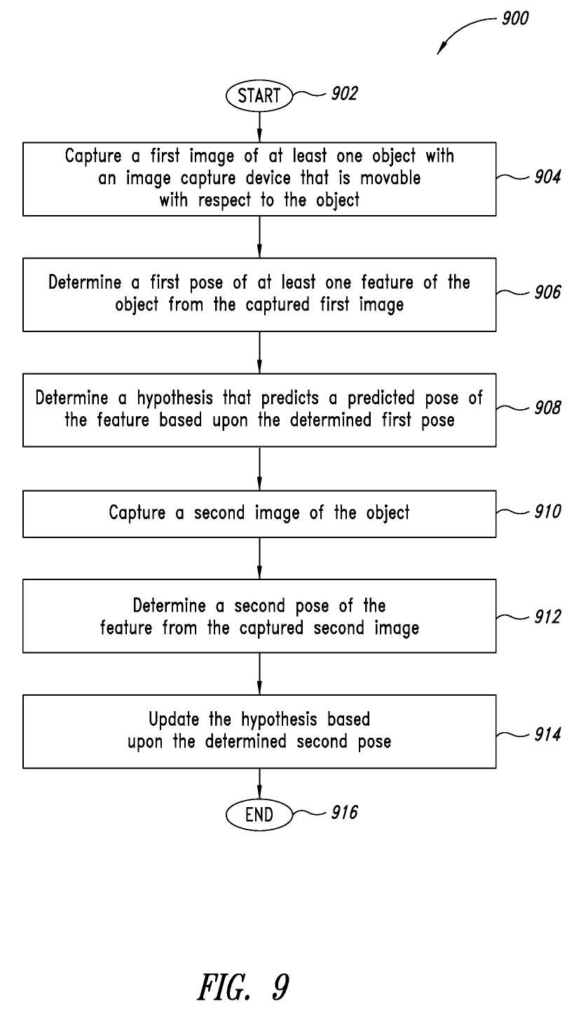

The process illustrated in FIG. 9 begins at block 902. At block 904, a first image of at least one object is captured with an image capture device that is moveable with respect to the object. At block 906, a first pose of at least one feature of the object is determined from the captured first image. At block 908, a hypothesis is determined that predicts a predicted pose of the feature based upon the determined first pose. At block 910, a second image of the object is captured. At block 912, a second pose of the feature is determined from the captured second image. At block 914, the hypothesis is updated based upon the determined second pose. The process ends at block 916.

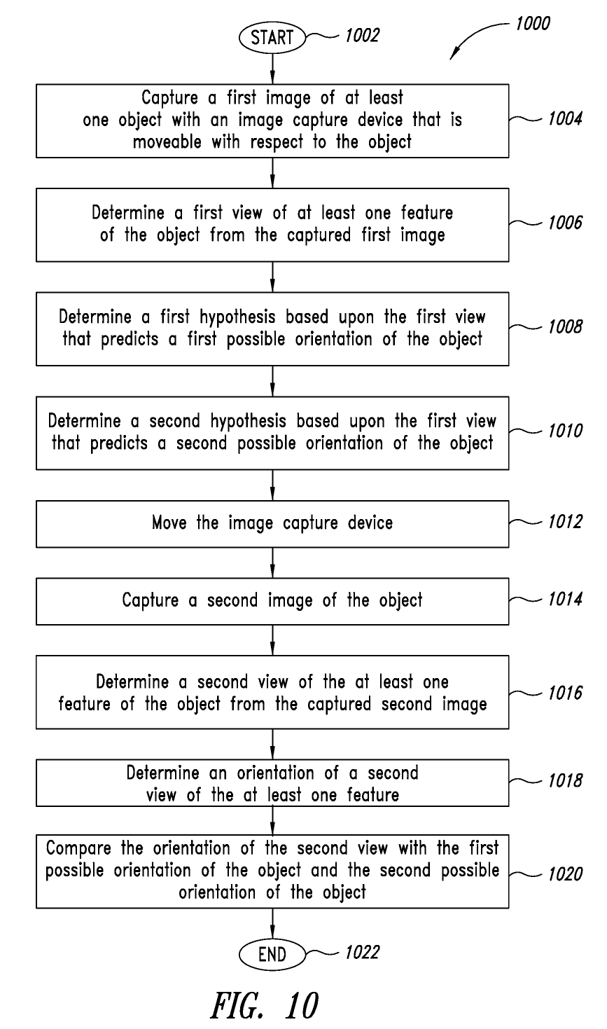

The process illustrated in FIG. 10 begins at block 1002. At block 1004, a first image of at least one object is captured with an image capture device that is moveable with respect to the object. At block 1006, a first view of at least one feature of the object is determined from the captured first image. At block 1008, a first hypothesis based upon the first view is determined that predicts a first possible orientation of the object. At block 1010, a second hypothesis based upon the first view is determined that predicts a second possible orientation of the object. At block 1012, the image capture device is moved. At block 1014, a second image of the object is captured. At block 1016, a second view of the at least one feature of the object is determined from the captured second image. At block 1018, an orientation of a second view is determined of the at least one feature. At block 1020, the orientation of the second view is compared with the first possible orientation of the object and the second possible orientation of the object. The process ends at block 1022.

In the above-described various embodiments, image capture device controller logic 214, hypothesis determination logic 218, and database 220 were described as residing in memory 204 of the control system 106. In alternative embodiments, the image capture device controller logic 214, hypothesis determination logic 218 and/or database 220 may reside in another suitable memory (not shown). Such memory may be remotely accessible by the control system 106. Or, the image capture device controller logic 214, hypothesis determination logic 218 and/or database 220 may reside in a memory of another processing system (not shown). Such a separate processing system may retrieve and execute the hypothesis determination logic 218 to determine and process hypotheses and other related operations, may retrieve and store information into the database 220, and/or may retrieve and execute the image capture device controller logic 214 to determine movement for the image capture device 114 and control the robot camera system 102.

In the above-described various embodiments, the image capture device 114 was mounted on a member 118c of the robot tool system 104. In alternative embodiments, the image capture device 114 may be mounted on the robot tool system 104 or mounted on a non-robotic system, such as a track system, chain/pulley system or other suitable system. In other embodiments, a moveable mirror or the like may be adjustable to provide different views for a fixed image capture device 114.

In the above-described various embodiments, a plurality of images are successively captured as the image capture device 114 is moved until the pose of an object is determined. The process may end upon validation of the above-described hypothesis. In an alternative embodiment, the process of successively capturing a plurality of images, and the associated analysis of the image data and determination of hypotheses, continues until a time period expires, referred to as a cycle time or the like. The cycle time limits the amount of time that an embodiment may search for an object of interest. In such situations, it is desirable to end the process, move the image capture device to the start position (or a different start position), and begin the process anew. That is, upon expiration of the cycle time, the process starts over or otherwise resets.

In other embodiments, if hypotheses for one or more objects of interest are determined and/or verified before expiration of the cycle time, the process of capturing images and analyzing captured image information continues so that other objects of interest are identified and/or their respective hypothesis determined. Then, after the current object of interest is engaged, the next object of interest has already been identified and/or its respective hypothesis determined before the start of the next cycle time. Or, the identified next object of interest may be directly engaged without the start of a new cycle time.

In yet other embodiments, if hypotheses for one or more objects of interest are determined and/or verified before expiration of the cycle time, a new starting position for the next cycle time for the image capture device 114 may be determined. In embodiments where the image capture device 114 is not physically attached to the device that engages the identified object of interest, the image capture device 114 may be moved to the determined position in advance of the next cycle time.

As noted above, in some situations, a hypothesis associated with an object of interest may be invalidated. Some embodiments determine at least one hypothesis for two or more objects using the same captured image(s). A “best” hypothesis is identified based upon having the highest confidence level or value. The “best” hypothesis is then selected for validation. As described above, motion of the image capture device 114 for the next captured image may be based on improving the view of the object associated with the selected hypothesis.

In the event that the hypothesis that was selected is invalidated, the process continues by selecting one of the remaining hypotheses that has not yet been invalidated. Accordingly, another hypothesis, such as the “next best” hypothesis that now has the highest confidence level or value, may be selected for further consideration. In other words, in the event that the current hypothesis under consideration is invalidated, another object and its associated hypothesis may be selected for validation. The above-described process of hypothesis validation is continued until the selected hypothesis is validated (or invalidated).

In such embodiments, additional images of the pile of objects 112 may be captured as needed until the “next best” hypothesis is validated. Then, pose of the object associated with the “next best” hypothesis may be determined. Furthermore, the movement of the image capture device 114 for capture of subsequent images may be determined based upon the “next best” hypothesis that is being evaluated. That is, the movement of the image capture device 114 may be dynamically adjusted to improve the view of the object in subsequent captured images.

In some embodiments, the feature on the object of interest is an artificial feature. The artificial feature may be painted on the object of interest or may be a decal or the like affixed to the object of interest. The artificial feature may include various types of information that assists in the determination of the hypothesis.

In the above-described various embodiments, the control system 106 (FIG. 1) may employ a microprocessor, a digital signal processor (DSP), an application specific integrated circuit (ASIC) and/or a drive board or circuitry, along with any associated memory, such as random access memory (RAM), read only memory (ROM), electrically erasable read only memory (EEPROM), or other memory device storing instructions to control operation.

The above description of illustrated embodiments, including what is described in the Abstract, is not intended to be exhaustive or to limit the invention to the precise forms disclosed. Although specific embodiments of and examples are described herein for illustrative purposes, various equivalent modifications can be made without departing from the spirit and scope of the invention, as will be recognized by those skilled in the relevant art. The teachings provided herein can be applied to other object recognition systems, not necessarily the exemplary robotic system embodiments generally described above.

The foregoing detailed description has set forth various embodiments of the devices and/or processes via the use of block diagrams, schematics, and examples. Insofar as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof. In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs running on one or more computers (e.g., as one or more programs running on one or more computer systems), as one or more programs running on one or more controllers (e.g., microcontrollers) as one or more programs running on one or more processors (e.g., microprocessors), as firmware, or as virtually any combination thereof, and that designing the circuitry and/or writing the code for the software and or firmware would be well within the skill of one of ordinary skill in the art in light of this disclosure.

In addition, those skilled in the art will appreciate that the control mechanisms taught herein are capable of being distributed as a program product in a variety of forms, and that an illustrative embodiment applies equally regardless of the particular type of signal bearing media used to actually carry out the distribution. Examples of signal bearing media include, but are not limited to, the following: recordable type media such as floppy disks, hard disk drives, CD ROMs, digital tape, and computer memory; and transmission type media such as digital and analog communication links using TDM or IP based communication links (e.g., packet links).

Reference throughout this specification to “one embodiment” or “an embodiment” means that a particular feature, structure or characteristic described in connection with the embodiment is included in at least one embodiment of the present systems and methods. Thus, the appearances of the phrases “in one embodiment” or “in an embodiment” in various places throughout this specification are not necessarily all referring to the same embodiment. Further more, the particular features, structures, or characteristics may be combined in any suitable manner in one or more embodiments.

From the foregoing it will be appreciated that, although specific embodiments of the invention have been described herein for purposes of illustration, various modifications may be made without deviating from the spirit and scope of the invention.

These and other changes can be made to the present systems and methods in light of the above-detailed description. In general, in the following claims, the terms used should not be construed to limit the invention to the specific embodiments disclosed in the specification and the claims, but should be construed to include all power systems and methods that read in accordance with the claims. Accordingly, the invention is not limited by the disclosure, but instead its scope is to be determined entirely by the following claims.

1. A method for identifying objects with a robotic system, the method comprising:
capturing an image of at least one object with an image capture device that is moveable with respect to the object;
processing the captured image to identify at least one feature of the at least one object; and
determining a hypothesis based upon the identified feature.

2. The method of claim 1, further comprising:
determining a difference between the identified feature and a corresponding reference feature of a known model of the object, such that determining the hypothesis is based at least in part upon the difference between the identified feature and the reference feature.

3. The method of claim 1, further comprising:
processing the captured image to identify a different feature of the at least one object; and
determining a difference between the identified different feature and a corresponding reference feature of the known model of the object, such that determining the hypothesis is based at least in part upon the difference between the identified different feature and the corresponding reference feature.

4. The method of claim 1, further comprising:
moving the image capture device;
capturing a new image of the at least one object with the image capture device;
processing the new captured image to identify the at least one feature; and
determining a pose of the at least one feature based upon the hypothesis and the feature identified in the new captured image.

5. The method of claim 4, further comprising:
determining a confidence level for the hypothesis based upon the determined pose; and
validating the hypothesis in response to the confidence level equaling at least a threshold.

6. The method of claim 5, further comprising:
determining that the pose of the object is valid in response to validation of the hypothesis.

7. The method of claim 4, further comprising:
determining a confidence level of the hypothesis based upon the determined pose;
invalidating the hypothesis in response to the confidence level being less than a threshold;
discarding the hypothesis;
capturing a new image of the object;
processing the new captured image to identify the at least one feature of the object; and
determining a new hypothesis based upon the identified at least one feature.

8. The method of claim 4, further comprising:
determining a new hypothesis based upon the identified feature in the new captured image.

9. The method of claim 1, further comprising:
determining a movement for the image capture device based at least in part on the hypothesis; and
moving the image capture device in accordance with the determined movement.

10. The method of claim 9 wherein moving the image capture device comprises:
changing the position of the image capture device.

11. The method of claim 9 wherein determining the movement for the image capture device comprises:
determining a direction of movement for the image capture device, wherein the image capture device is moved in the determined direction of movement.

12. The method of claim 9, further comprising:
capturing a new image after movement of the image capture device;
processing the captured new image to re-identify the feature;
determining a new movement for the image capture device based at least in part on the re-identified feature; and
moving the image capture device in accordance with the determined new movement.

13. The method of claim 9, further comprising:
determining at least one lighting condition around the object such that the movement for the image capture device is based at least in part upon the determined lighting condition.

14. The method of claim 13 wherein a first direction of movement increases a lighting condition of the object in a subsequently captured image of the object.

15. The method of claim 1 wherein determining the hypothesis based upon the identified feature comprises:
determining a difference between the identified feature and a corresponding reference feature of a known model of the object; and
determining a predicted pose of the object based at least in part upon the difference between the identified feature and the corresponding reference feature, wherein the hypothesis is based at least in part upon the predicted pose.

16. The method of claim 1 wherein the image includes a plurality of objects, further comprising:
processing the captured image to identify the feature associated with at least two of the plurality of objects that are visible in the captured image;
determining at least one initial hypothesis for each of the at least two objects based upon the identified feature;
determining a confidence level for each of the initial hypotheses determined for the at least two objects; and
selecting the initial hypothesis with the greatest confidence level.

17. The method of claim 16, further comprising:
validating the selected initial hypothesis in response to the confidence level equaling at least a threshold.

18. The method of claim 17, further comprising:
determining a pose of the object associated with the validated initial hypothesis.

19. The method of claim 1 wherein the captured image includes an artificial feature on the object, further comprising:
processing the captured image to identify the artificial feature; and
determining the first hypothesis based upon the identified artificial feature.

20. The method of claim 19 wherein the artificial feature is painted on the object.

21. The method of claim 19 wherein the artificial feature is a decal affixed on the object.

22. A robotic system that identifies objects, comprising:
an image capture device mounted for movement with respect to a plurality of objects; and
a processing system communicatively coupled to the image capture device, and operable to:
receive a plurality of images captured by the image captive device;
identify at least one feature for at least two of the objects in the captured images;
determine at least one hypothesis predicting a pose for the at least two objects based upon the identified feature;
determine a confidence level for each of the hypotheses; and
select the hypothesis with the greatest confidence level.

23. The system of claim 22 where, in response to the confidence level being less than a threshold, the processing system is operable to:
determine a movement of the image capture device based upon the selected hypothesis; and
generate a movement command signal, wherein the image capture device is moved in accordance with the movement command signal.

24. The system of claim 23, further comprising:
a robot arm member with the image capture device secured thereon and communicatively coupled to the processing system so as to receive the movement command signal, wherein a robot arm member moves the image capture device in accordance with the movement command signal.

25. The system of claim 22 wherein the processing system is operable to validate the selected hypothesis in response to the corresponding confidence level equaling at least a threshold.

26. The system of claim 25 wherein the processing system is operable to determine a pose of the object in response to validation of the selected hypothesis.

27. A method for identifying objects with a robotic system, the method comprising:
capturing a first image of at least one object with an image capture device that is moveable with respect to the object;
determining a first hypothesis based upon at least one feature identified in the first image, wherein the first hypothesis is predictive of a pose of the feature;
capturing a second image of the at least one object after a movement of the image capture device;
determining a second hypothesis based upon the identified feature, wherein the second hypothesis is predictive of the pose of the feature; and
comparing the first hypothesis with the second hypothesis.

28. The method of claim 27 wherein determining the first and second hypotheses comprises:
determining a difference between the identified feature in the first captured image and a reference feature of a known model of the object;
determining the first hypothesis based at least in part upon the determined difference between the identified feature in the first captured image and the reference feature;
determining a difference between the identified feature in the second captured image and the reference feature of the known model of the object; and
determining the second hypothesis based at least in part upon the determined difference between the identified feature in the second captured image and the reference feature.

29. The method of claim 28 wherein determining the first hypothesis comprises:
processing the first captured image to identify a second feature of the at least one object;
determining a second difference between the identified second feature and a second reference feature of the known model of the object; and
determining the first hypothesis based at least in part upon a difference between the identified second feature and the second reference feature.

30. The method of claim 27, further comprising:
determining a confidence level based upon the first hypothesis and the second hypothesis;
validating the first and second hypotheses in response to the confidence level equaling at least a first threshold; and
invalidating the first and second hypotheses in response to the confidence level being less than a second threshold.

31. The method of claim 30, further comprising:
determining a pose of the object in response to validation of the first and second hypotheses.

32. The method of claim 30 where, in response to invalidating the first and the second hypothesis, the method further comprises:
discarding the first hypothesis and the second hypothesis;
capturing a new first image of the object;
determining a new first hypothesis based upon the at least one feature identified in the new first image, wherein the new first hypothesis is predictive of a new pose of the feature;
capturing a new second image of the at least one object after a subsequent movement of the image capture device;
determining a new second hypothesis based upon the identified feature, wherein the new second hypothesis is predictive of the new pose of the feature; and
comparing the new first hypothesis with the new second hypothesis.

33. The method of claim 30 where, in response to the confidence level being less than the first threshold, the method further comprises:
changing at least a relative pose between the image capture device and the object;
capturing another image of at least the object; and
determining a third hypothesis based upon the identified feature, wherein the third hypothesis is predictive of the pose of the feature.

34. The method of claim 33, further comprising:
selecting one of the first and the second hypotheses;
comparing the third hypothesis with at least the selected hypothesis;
determining a new confidence level of the compared third hypothesis and selected hypothesis; and
validating at least the third hypothesis in response to the new confidence level equaling at least the first threshold.

35. The method of claim 34, further comprising:
determining a pose of the object in response to validation of the third hypothesis.

36. The method of claim 27, further comprising:
determining the movement for the image capture device based at least in part on the first hypothesis; and
moving the image capture device in accordance with the determined movement.

37. A method for identifying one of a plurality of objects with a robotic system, the method comprising:
capturing an image of a plurality of objects;
processing the captured image to identify a feature associated with at least two of the objects visible in the captured image;
determining a hypothesis for the at least two visible objects based upon the identified feature;
determining a confidence level for each of the hypotheses for the at least two visible objects; and
selecting the hypotheses with the greatest confidence level.

38. The method of claim 37 wherein determining the hypothesis for the visible objects based upon the identified feature comprises:
comparing the identified feature of the objects with a corresponding reference feature of a reference object, wherein the reference object corresponds to the plurality of objects.

39. The method of claim 37, further comprising:
validating the selected hypothesis in response to the confidence level of the selected hypothesis equaling at least a threshold.

40. The method of claim 39, further comprising:
determining a pose of the object associated with the selected hypothesis in response to validation of the selected hypothesis.

41. The method of claim 40, further comprising:
moving an end effector physically coupled to a robot arm to the determined pose of the object associated with the selected hypothesis; and
grasping the object associated with the selected hypothesis with the end effector.

42. The method of claim 37, further comprising:
comparing the confidence level of the selected hypothesis with a threshold;
invalidating the selected hypothesis in response to the confidence level being less than the threshold; and
selecting a remaining one of the hypotheses.

43. A method for identifying objects using a robotic system, the method comprising:
capturing a first image of at least one object with an image capture device that is moveable with respect to the object;
determining a first pose of at least one feature of the object from the captured first image;
determining a hypothesis that predicts a predicted pose of the feature based upon the determined first pose;
capturing a second image of the object;
determining a second pose of the feature from the captured second image; and
updating the hypothesis based upon the determined second pose.

44. The method of claim 43, further comprising:
determining a confidence level of the hypothesis;
validating the hypothesis in response to the confidence level equaling at least a threshold; and
determining a pose of the object based upon the predicted pose in response to validation of the hypothesis.

45. The method of claim 44 where, in response to the first confidence level being less than the threshold, the method further comprises:
again moving the image capture device;
capturing a third image of the object;
determining a third pose of the feature from the captured third image; and
updating the hypothesis based upon the third pose.

46. A method for identifying objects using a robotic system, the method comprising:
capturing a first image of at least one object with an image capture device that is moveable with respect to the object;
determining a first view of at least one feature of the object from the captured first image;
determining a first hypothesis based upon the first view that predicts a first possible orientation of the object;
determining a second hypothesis based upon the first view that predicts a second possible orientation of the object;
moving the image capture device;
capturing a second image of the object;
determining a second view of the at least one feature of the object from the captured second image;
determining an orientation of a second view of the at least one feature; and
comparing the orientation of the second view with the first possible orientation of the object and the second possible orientation of the object.

47. The method of claim 46, further comprising:
selecting one of the first hypothesis and the second hypothesis that compares closest to the orientation of the second view.
